(19) United States
(12) Patent Application Publication
(10) Pub. No.: US 2006/0284543 A1
(43) Pub. Date: Dec. 21, 2006

(54) Ferroelectric cold cathode and ferroelectric field emission device including the ferroelectric cold cathode

(76) Inventors: Deuk-Seok Chung, Seongnam-si (KR); Yong-Wan Jin, Seoul (KR); In-Taek Han, Seoul (KR); Jun-Hee Choi, Seongnam-si (KR)

Correspondence Address: Robert E. Bushnell, Suite 300, 1522 K Street, N.W., Washington, DC, 20005, US

(21) Appl. No.: 11/449,736

(22) Filed: Jun. 9, 2006

(30) Foreign Application Priority Data
Jun. 18, 2005 (KR) 10-2005-0052722

(51) Int. Cl. H01J 1/30; H01J 63/04

(52) U.S. Cl. 313/495

(57) ABSTRACT

A ferroelectric cold cathode and a ferroelectric field emission device including the ferroelectric cold cathode includes: a substrate; a lower electrode layer arranged on a upper surface of the substrate, the lower electrode layer including a conductive material; a ferroelectric layer arranged on a upper surface of the lower electrode, the ferroelectric layer including a ferroelectric material; and an upper electrode including an ultrafine linear material net arranged on the ferroelectric layer and exposing a portion of the upper surface of the ferroelectric layer through a plurality of net holes of conductive ultrafine linear material particles distributed in a net structure.

### CLAIM OF PRIORITY

This application makes reference to, incorporates the same herein, and claims all benefits accruing under 35 U.S.C.§119 from an application for FERROELECTRIC COLD CATHODE AND FERROELECTRIC FIELD EMISSION DE VICE COMPRISING THE SAME earlier filed in the Korean Intellectual Property Office on the 18^{th} of Jun. 2005 and there duly assigned Serial No. 10-2005-0052722.

### BACKGROUND OF THE INVENTION

1. Field of the Invention

The present invention relates to a cold cathode and a field emission device. More particularly, the present invention relates to a ferroelectric cold cathode and a field emission device, which includes a ferroelectric layer arranged between an upper electrode and a lower electrode and emitting electrons by the application of a field pulse between the upper electrode and the lower electrode.

2. Description of the Related Art

Ferroelectric materials are a type of dielectric, namely, electrical insulators, and have a spontaneous polarization which can be reversed by the application of an electric field. Using this characteristic of ferroelectric materials, a ferroelectric surface can be made to conduct electrons, and the electrons can be emitted by the application of a field pulse under a relatively weak vacuum.

A conventional ferroelectric cold cathode includes striped upper electrodes arranged 8 on an upper surface of a ferroelectric substrate. Electrons emitted by the upper electrode are distributed on the upper surface of the ferroelectric substrate exposed in the spaces between the striped upper electrodes.

A negative pulse voltage is supplied to a lower electrode and the directions of polarization of the ferroelectric substrate are reversed. Then, electrons which are conducted at the upper surface of the ferroelectric substrate are emitted by a repulsive force.

However, while the ferroelectric substrate is polarized upward, a relatively small potential difference occurs between the upper surface of the ferroelectric substrate and the upper electrodes. To provide an emission current with a large cold cathode, a large number of electrons must be supplied from the upper electrodes to the upper surface of the ferroelectric substrate despite the small potential difference. Furthermore, a cold cathode must have an upper electrode structure in which electrons which received a repulsive force during polarization and a reversal of the polarization of the ferroelectric material are not emitted to the upper electrodes again but are emitted upward.

Moreover, a planar display device which emits light by collision of electrons and a fluorescent material is provided by coating an anode substrate with a fluorescent material, the anode substrate facing the cold cathode and separated from the cold cathode by a predetermined distance. To provide such a planar display device, the cold cathode structure must be formed on a glass substrate. However, the sintering temperature of the conventional ferroelectric substrate is above 1000° C., which is much higher than the heat resisting temperature of a glass substrate widely used for a display device. Therefore, for a field emission device using a ferroelectric cold cathode, a ferroelectric cathode which has a lower sintering temperature than the heat resisting temperature of a glass substrate is needed.

### SUMMARY OF THE INVENTION

The present invention provides a cold cathode forming an upper electrode, which makes electron emission and resupplying easier by using a net of particles of conductive ultrafine linear materials such as carbon nanotubes.

The present invention also provides a cold cathode which can be applied to a field emission display device by lowering the sintering temperature of the ferroelectric substrate so as to be lower than the heat resisting temperature of a glass substrate.

According to an aspect of the present invention, the ferroelectric cold cathode includes: a substrate; a lower electrode layer arranged on a upper surface of the substrate, the lower electrode layer including a conductive material; a ferroelectric layer arranged on a upper surface of the lower electrode, the ferroelectric layer including a ferroelectric material; and an upper electrode including an ultrafine linear material net arranged on the ferroelectric layer and exposing a portion of the upper surface of the ferroelectric layer through a plurality of net holes of conductive ultrafine linear material particles distributed in a net structure.

The ultrafine linear material net can be a net of nanolines, nanotubes or nanorods made of a conductive material distributed and fixed in thin layers in a net shape. A predetermined waveform of voltage is supplied to the ultrafine linear material net, which is the upper electrode layer, and to the lower electrode layer. Electrons flow to the surface of the ferroelectric layer adjacent to the ultrafine linear material net, and the electrons are emitted to the outside of the net when a dielectric polarization is reversed.

A number of net holes are formed in the ultrafine linear material net. Also, as the net is formed of pieces of ultrafine linear material such as nanolines, nanotubes, and nanorods, the ends of the pieces form a narrow aperture with the surface of the ferroelectric layer. The aspect ratio of the ultrafine linear material is high and the ends thereof have a great field enhancement factor, and thus electrons can be easily supplied despite the small difference of voltages between the ultrafine linear material net and the surface of the ferroelectric layer.

The ferroelectric layer can be nanosized beads of a ferroelectric material stacked in a plurality of layers. The ferroelectric material can be ceramics such as lead zirconate titanate (PZT), La-modified zirconate titanate (PLZT), and barium titanate (BT). The sintering temperature of ceramics varies according to the size of the particles when sintered. That is, the smaller the size of particles, the lower the temperature of sintering process.

A high temperature of more than 1000° C. is needed to sinter the ferroelectric layer formed of microsized particles in the prior art. However, the sintering process of the ferroelectrice layer formed of nanosized beads can be performed at a temperature lower than 630° C. which is the heat resisting temperature of a glass substrate for a planar display device. Accordingly, according to an aspect of the present invention, a ferroelectric cold cathode structure using a glass substrate can be provided.

Also, the ferroelectric layer formed of nanosized beads can have fine curves along the surface of the particles of the beads which are the top layer. The curves can provide a proper aperture between the surface of the ferroelectric layer and the upper electrode layer.

According to another aspect of the present invention, the field emission device comprising a ferroelectric cold cathode and an anode located on a front substrate disposed a predetermined distance from the ferroelectric cold cathode, wherein electrons emitted from the cold cathode hit the anode due to an electric field, the ferroelectric cold cathode including: a rear substrate; a lower electrode layer formed of a conductive material on a upper surface of the substrate; a ferroelectric layer formed of a ferroelectric material on a upper surface of the lower electrode; and a ultrafine linear material net forming an upper electrode the ferroelectric layer and exposing a portion of the upper surface of the ferroelectric layer through a plurality of net holes formed of conductive ultrafine linear material particles distributed in a net structure.

### BRIEF DESCRIPTION OF THE DRAWINGS

A more complete appreciation of the present invention and many of the attendant advantages thereof, will be readily apparent as the present invention becomes better understood by reference to the following detailed description when considered in conjunction with the accompanying drawings in which like reference symbols indicate the same or similar components, wherein:

FIGS. 1A and 1B are views of the structure and principle of operation of a conventional ferroelectric cold cathode;

FIG. 2 is a cross-sectional view of a ferrroelectric field emission device according to an embodiment of the present invention;

FIG. 3 is a cross-sectional view of a ferroelectric cold cathode according to an embodiment of the present invention;

FIG. 4 is a plane view of a net of ultrafine linear materials formed of carbon nanotubes;

FIG. 5 is a three-dimensional view of the embodiment of FIG. 3; and

FIGS. 6A through 6D are views of the principle of operation of the ferroelectric cold cathode according to an embodiment of the present invention.

### DETAILED DESCRIPTION OF THE INVENTION

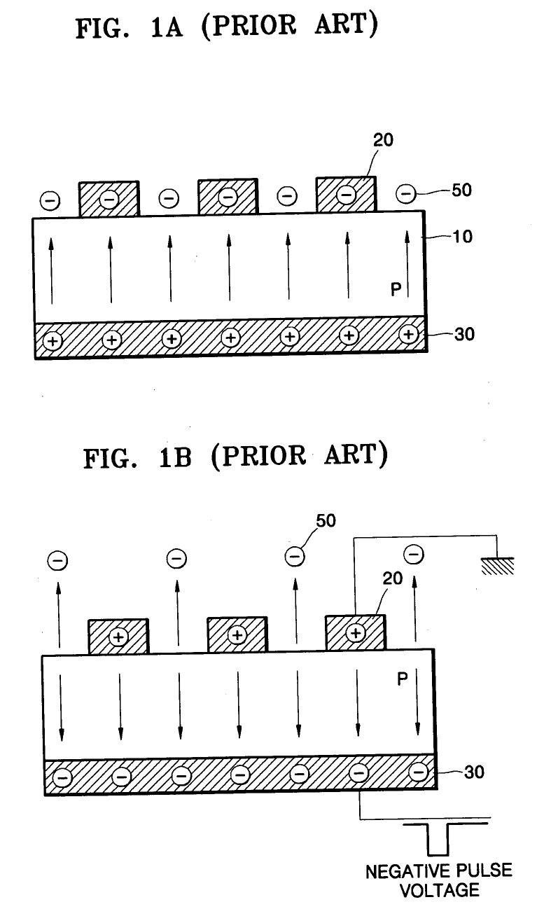

FIGS. 1A and 1B are views of a structure of a conventional ferroelectric cold cathode suggested by H. Gundel. The ferroelectric cathode includes striped upper electrodes 20 on the upper surface of a ferroelectric substrate 10 (“Ferroelectrics, Vol. 100, (1989).1”).

Referring to FIG. 1A, electrons 50 emitted by the upper electrode 20 are distributed on the upper surface of the ferroelectric substrate 10 exposed in the intervals between the striped upper electrodes 20. Next, referring to FIG. 1B, a negative pulse voltage is supplied to a lower electrode 30, and the directions of polarization of the ferroelectric substrate 10 are reversed. Then, electrons which are conducted at the upper surface of the ferroelectric substrate 10 are emitted by repulsive force.

However, while the ferroelectric substrate 10 is polarized upward, a relatively small potential difference occurs between the upper surface of the ferroelectric substrate 10 and the upper electrodes 20. To provide an emission current with a large cold cathode, a large number of electrons must be supplied from the upper electrodes 20 to the upper surface of the ferroelectric substrate 10 despite the small potential difference. Furthermore, a cold cathode must have an upper electrode structure in which electrons which received a repulsive force during polarization and reversal of the polarization of the ferroelectric substrate 10 are not emitted to the upper electrodes 20 again but are emitted upward.

Moreover, a planar display device which emits light by collision of electrons and a fluorescent material is provided by coating an anode substrate with a fluorescent material, the anode substrate facing the cold cathode and separated from the cold cathode by a predetermined distance. To provide such a planar display device, the cold cathode structure must be formed on a glass substrate. However, the sintering temperature of the conventional ferroelectric substrate is above 1000° C., which is much higher than the heat resisting temperature of a glass substrate widely used for a display device. Therefore, for a field emission device using a ferroelectric cold cathode, a ferroelectric cathode which has a lower sintering temperature than the heat resisting temperature of a glass substrate is needed.

The present invention is described more fully below with reference to the accompanying drawings, in which exemplary embodiments of the present invention are shown.

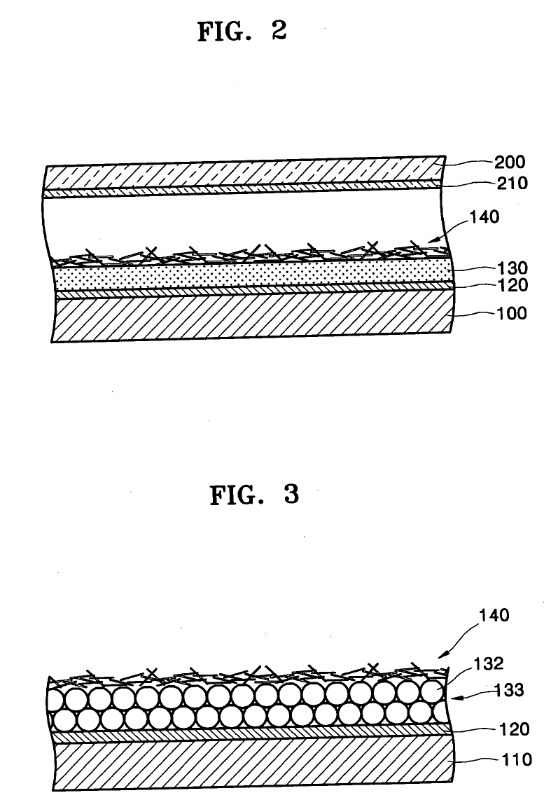

FIG. 2 is a cross-sectional view of a ferroelectric field emission device according to an embodiment of the present invention. The ferroelectric field emission device according to the present embodiment includes a ferroelectric cold cathode formed on a rear substrate 100; a front substrate 200 disposed a predetermined distance from the ferroelectric cold cathode; and an anode 210 disposed on a surface of the front substrate 200 facing the cold cathode.

A lower electrode 120 is formed of a conductive metal or non-metal on the upper surface of the rear substrate 100. A ferroelectric layer 130 is formed of a material having ferroelectric properties on the upper surface of the lower electrode 120. Ferroelectric materials are a type of dielectric having a spontaneous polarization, which can be reversed by an external electric field. There are more than a hundred known ferroelectric materials, any of which can be used depending on the desired properties. Specifically, ceramics such as lead zirconate titanate (PZT), La-modified zirconate titanate (PLZT), and barium titanate (BT) can be used.

A carbon nanotube net 140 is formed as an upper electrode layer on the upper surface of the ferroelectric layer 130, facing the lower electrode layer 120. The carbon nanotube net 140 is, for example, one of the ultrafine linear material nets that is applicable to the present embodiment. The carbon nanotube net 140 has a fixed net structure in which carbon nanotubes particles are evenly distributed. The diameter of the carbon nanotube particles varies from a few to a dozen nanometers, and the length varies depending on the growing time. The length can vary from a few to hundreds or more micrometers.

Generally, a carbon nanotube has a very large Van der Waals force due to its large surface area. Thus, an even distribution can be hard to obtain due to the property of the nanotubes binding together by themselves when they are mixed with a polymer or other solvents. However, recently, a carbon nanotube distribution liquid in which carbon nanotube particles are distributed and stabilized has been disclosed. The carbon nanotube net can be formed by spin coating the carbon nanotube distribution liquid on the upper surface of the ferroelectric layer 130 and baking at a relatively low temperature in the range 100° C. through 150° C.

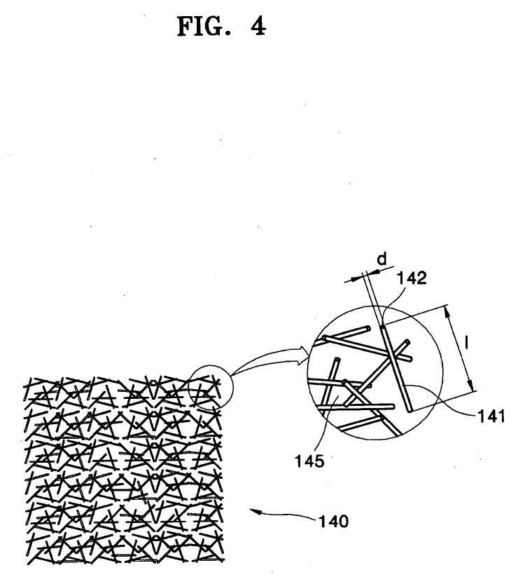

FIG. 3 is a cross-sectional view of a ferroelectric cold cathode according to an embodiment of the present invention. The cold cathode of the present embodiment includes a glass substrate 110 and a ferroelectric layer 133 formed of a plurality of ferroelectric nanobeads 132 between the lower electrode layer 120 and the carbon nanotube net 140. The ferroelectric layer 133 of the present embodiment can have a stack structure of a plurality of densely arranged nano-size simple layers formed of nanobeads. As the size of the particles becomes smaller, ceramic materials can be sintered at lower temperatures. The ferroelectric layer 133 formed of ferroelectric nanobeads 132 having diameters in the range of a few to a dozen or more nanometers are sintered at a temperature lower than 630° C., the heat resisting temperature of a glass substrate for planar display devices. Accordingly, the cold cathode according to the present embodiment can be used in a planar display device comprising a glass substrate.

The methods of producing ferroelectric nanobeads and forming nanobead simple layers are not particularly limited, and various methods can be used to provide ferroelectric layers using nanobeads. For example, a nanobead BaTiO3 can be obtained by fabricating nano-size BaTiO3 powder using a glycothermal method suggested by Lim Dae Young in “Journal of Korean Ceramic Society” (2002). These nanobeads can also be formed into nanobead simple layers using a dipping process or a Langmiur-Blodgett (LB) method. Dipping refers to dipping a substrate into a ceramics slurry comprising ceramic particles mixed in a solvent and pulling out the substrate to form a layer of ceramic particles. The LB method refers to arranging a layer on a surface of a subphase liquid and pulling up the substrate with a predetermined speed so that the layer adheres to the surface of the substrate.

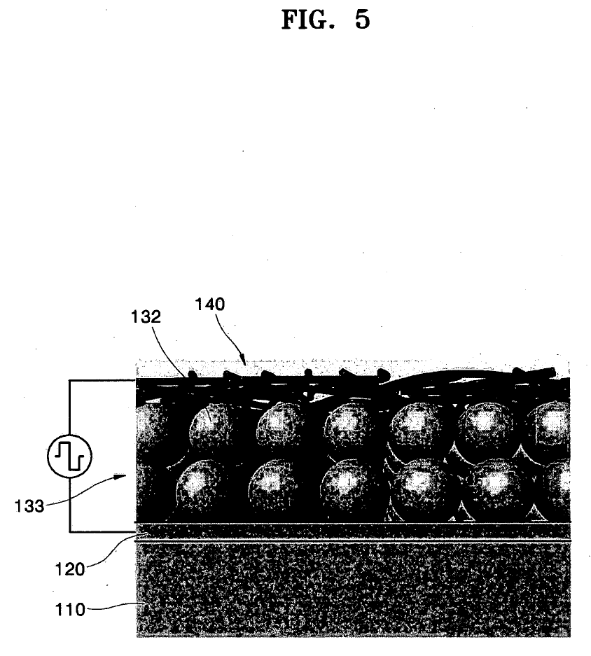

FIG. 4 is a plane view of a net of ultrafine linear materials formed of carbon nanotubes. Carbon nanotubes are one example of ultrafine linear materials such as nanotubes, nanowires, and nanorods, and are described in greater detail as follows.

A carbon nanotube net 140 is formed of a number of carbon nanotube particles 141. As described previously, nanotube particles can be formed into thin layers by spin coating while being distributed in a solvent. Accordingly, the carbon nanotube net 140 has a net structure formed of unevenly distributed carbon nanotube particles 141. The net 140 has a large number of net holes 145 and a surface of the ferroelectric layer is exposed to the outside through the net holes 145.

The carbon nanotube net 140 is formed of carbon nanotube particles 141, and thus several carbon nanotube ends are disposed in each net hole. The aspect ratio, that is, the ratio of length L to the diameter D, of the carbon nanotube particles is very large. Thus the field focus index is also very large. Accordingly, a number of electrons can move to the surface of the ferroelectric layer from the the carbon nanotube ends 142 by a tunneling effect even when a small potential difference occurs between the carbon nanotube net 140 and the surface of the ferroelectric layer.

The above properties appear in other forms of nanomaterials and are found not only in carbon nanotubes. Therefore, the upper electrode layer of the cold cathode of the present invention can include a net of distributed ultrafine linear particles with a large aspect ratio, such as nanotubes, nanowires, and nanorods.

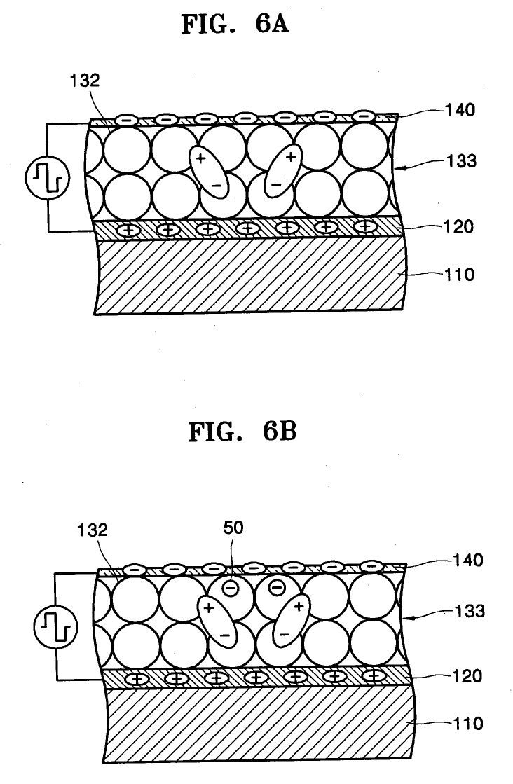

FIG. 5 is a three-dimensional view of the embodiment of FIG. 3. It helps to visually understand the ferroelectric layer 133 and the carbon nanotube net 140. As shown in FIG. 5, the surface of the ferroelectric layer 133 is formed of a plurality of nanobeads 132 and is curved along the curved surfaces of the nanobeads of the top layer. Accordingly, the ferroelectric layer 133 has a large surface area, and can maintain a predetermined distance from the carbon nanotube net 140.

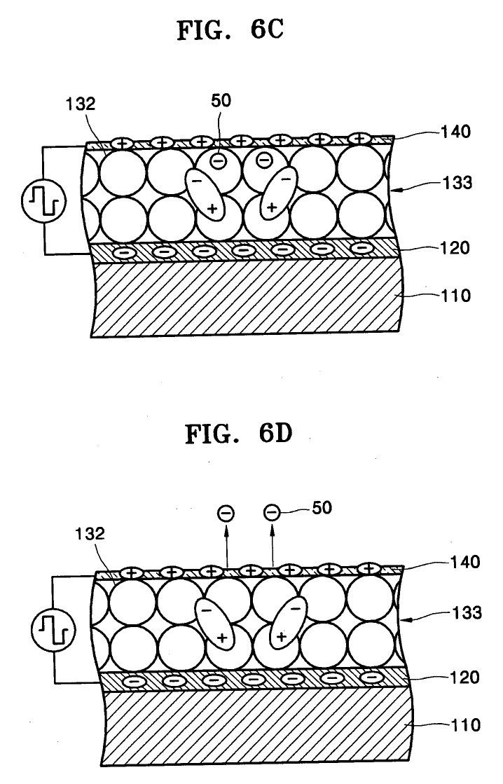

FIGS. 6A through 6D are views of the principle of operation of the ferroelectric cold cathode according to the present invention. First, as shown in FIG. 6A, when an upward field is formed on the ferroelectric layer 133 by the lower and upper electrodes 120 and 140, the ferroelectric layer 133 is polarized upward. At this point, electrons 50 emitted from the carbon nanotube net 140, that is, from the upper electrode, are attached to the surface of the ferroelectric nanobeads 132 of the upper side of the ferroelectric layer 133 as shown in FIG. 6B.

Referring to FIG. 6C, when the electric field of the ferroelectric layer 133 is reversed by the lower and upper electrodes 120 and 140, the ferroelectric layer 133 is also polarized downward. Then, the ferroelectric nanobeads 132 of the upper surface of the ferroelectric layer 133 are turned into negative charges, and the electrons 50 are emitted through the net holes 145 of the carbon nanotube net 140 as shown in FIG. 6D. Although not shown in FIGS. 6A through 6D, when an anode is placed on the upper side of the cold cathode, the emitted electrons 50 are accelerated by the strong electric field between the anode and the cold cathode and collide with the surface of the anode.

According to the present invention, the ferroelectric cold cathode and the ferroelectric 8 field emission device including the ferroelectric cold cathode make emission and resupplying of electrons easier by using a net formed of conductive ultrafine linear materials such as carbon nanotubes. Furthermore, by decreasing the sintering temperature of the ferroelectric layer below the heat resisting temperature of a glass substrate, the ferroelectric layer can be applied to a field emission display device.

While the present invention has been particularly shown and described with reference to exemplary embodiments thereof, it will be understood by those of ordinary skill in the art that various modifications in form and detail can be made therein without departing from the spirit and scope of the present invention as defined by the following claims.

What is claimed is:

1. A ferroelectric cold cathode, comprising:
a substrate;
a lower electrode layer arranged on a upper surface of the substrate, the lower electrode layer including a conductive material;
a ferroelectric layer arranged on a upper surface of the lower electrode, the ferroelectric layer including a ferroelectric material; and
an upper electrode including an ultrafine linear material net arranged on the ferroelectric 8 layer and exposing a portion of the upper surface of the ferroelectric layer through a plurality of net holes of conductive ultrafine linear material particles distributed in a net structure.

2. The cold cathode of claim 1, wherein a diameter of the ultrafine linear material particles is in a range of from a few to hundreds of nanometers, and wherein the ultrafine linear material particles include at least one of nanotubes, nanowires, and nanorods.

3. The cold cathode of claim 1, wherein the ultrafine linear material particles comprise carbon nanotubes.

4. The cold cathode of claim 1, wherein the ferroelectric layer comprises a plurality of ferroelectric nanobeads.

5. The cold cathode of claim 4, wherein the ferroelectric layer is arranged by one of a dipping process or a Langmuir-Blodgett method and sintered.

6. The cold cathode of claim 4, wherein the substrate comprises a glass substrate.

7. A field emission device comprising a ferroelectric cold cathode and an anode located on a front substrate disposed a predetermined distance from the ferroelectric cold cathode, wherein electrons emitted from the cold cathode hit the anode due to an electric field, the ferroelectric cold cathode comprising:
a substrate;
a lower electrode layer arranged on a upper surface of the substrate, the lower electrode layer including a conductive material;
a ferroelectric layer arranged on a upper surface of the lower electrode, the ferroelectric layer including a ferroelectric material; and
an upper electrode including an ultrafine linear material net arranged on the ferroelectric layer and exposing a portion of the upper surface of the ferroelectric layer through a plurality of net holes of conductive ultrafine linear material particles distributed in a net structure.

8. The ferroelectric field emission device of claim 7, wherein a diameter of the ultrafine linear material particles is in a range of from a few to hundreds of nanometers, and wherein the ultrafine linear material particles include at least one of nanotubes, nanowires, and nanorods.

9. The ferroelectric field emission device of claim 7, wherein the ultrafine linear material particles comprise carbon nanotubes.

10. The ferroelectric field emission device of claim 7, wherein the ferroelectric layer comprises a plurality of ferroelectric nanobeads.

11. The ferroelectric field emission device of claim 10, wherein the ferroelectric layer is arranged by one of a dipping process or a Langmuir-Blodgett method and sintered.

12. The ferroelectric field emission device of claim 10, wherein the substrate comprises a glass substrate.
